(19) United States
(12) Patent Application Publication
(10) Pub. No.: US 2022/0052502 A1
(43) Pub. Date: Feb. 17, 2022

(54) BISMUTH DOPED FIBER AMPLIFIER

(71) Applicant: OFS FITEL, LLC, Norcross, GA (US)

(72) Inventors: Jiawei Luo, Somerset, NJ (US); Vitaly Mikhailov, Oxford, NJ (US)

(73) Assignee: OFS Fitel, LLC, Norcross, GA (US)

(21) Appl. No.: 17/274,362

(22) PCT Filed: Sep. 13, 2019
(86) PCT No.: PCT/US2019/051024

§ 371 Date: Mar. 8, 2021

Related U.S. Application Data
(60) Provisional application No. 62/730,766, filed on Sep. 13, 2018.

(51) Int. Cl. H01S 3/067; C03C 13/04; H01S 3/16; H01S 3/094

(52) U.S. Cl. CPC H01S 3/06708; C03C 13/046; H01S 3/06754; H01S 3/2316; H01S 3/094011; C03C 2213/00; H01S 3/1601

(57) ABSTRACT

Bismuth (Bi) doped optical fibers (BiDF) and Bi-doped fiber amplifiers (BiDFA) are shown and described. The BiDF comprises a gain band and an auxiliary band. The gain band has a first center wavelength (λ1) and a first six decibel (6 dB) gain bandwidth. The auxiliary band has a second center wavelength (λ2), with λ2>λ1. The system further comprises a signal source and a pump source that are optically coupled to the BiDF. The signal source provides an optical signal at λ1, while the pump source provides pump light at a pump wavelength (λ3).

### CROSS REFERENCE TO RELATED APPLICATIONS

This application claims the benefit of U.S. provisional patent application Ser. No. 62/730,766, filed 2018 Sep. 13, having the title “Bismuth Doped Fiber Amplifier to Extend O-Band,” by DiGiovanni, which is incorporated herein by reference in its entirety.

### BACKGROUND

### Field of the Disclosure

The present disclosure relates generally to optics and, more particularly, to optical fiber amplifiers.

### Description of Related Art

The O-band (for original band) in optical fiber communications systems operates between a wavelength (λ) range from approximately 1260 nanometers (˜1260 nm) to ˜1360 nm. One advantage of operating in the O-band is that transmitter wavelengths are located near the zero-dispersion wavelength (λ0). Thus, neither optical nor electronic chromatic dispersion compensation is typically required. Because of these and other benefits, there are ongoing efforts to improve optical fiber systems and processes that operate within the O-band.

### SUMMARY

The present disclosure provides optical systems employing Bismuth (Bi) doped optical fibers. One embodiment of the system comprises a Bi-doped optical fiber (or Bi-doped fiber (BiDF)) comprising with a gain band and an auxiliary band. The gain band has a first center wavelength (λ1) and a first six decibel (6 dB) gain bandwidth. The auxiliary gain band has a second center wavelength (λ2). The system further comprises a signal source that is optically coupled to the BiDF. The signal source provides an optical signal within the gain band to the BiDF. Additionally, a pump source is optically coupled to the BiDF. The pump source provides pump light at a pump wavelength (λ3) to the BiDF. For some embodiments, multiple pump sources provide multiple wavelengths of pump light to the BiDF.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a diagram showing one embodiment of a system comprising a bismuth (Bi) doped optical fiber (or Bi-doped gain fiber, or truncated to Bi-doped fiber (BiDF)).

FIG. 1B is a graph showing amplified spontaneous emission (ASE) in the system of FIG. 1A for pump lasers with central wavelengths (λ) of approximately 1155 nanometers (˜1155 nm), ˜1175 nm, ˜1195 nm, ˜1215 nm, and ˜1235 nm.

FIG. 1C is a graph showing dependency of gain (G), gain peak (in micrometers (μm)), and power conversion efficiency (PCE) on pump λ for the system of FIG. 1A.

FIG. 1D is a graph showing input and output spectra from the system of FIG. 1A for a pump λ of ˜1195 nm.

FIG. 1E is a graph showing input and output spectra from the system of FIG. 1A for a pump λ of ˜1235 nm.

FIG. 2A is a graph showing G and noise figure at ˜500 milliwatt (mW) pump power for one embodiment of a counter-pumped Bi-doped fiber amplifier (BiDFA) system.

FIG. 2B is a graph showing G and noise figure at ˜750 mW pump power for the counter-pumped BiDFA system that was used to obtain the graph of FIG. 2A.

FIG. 3A is a graph showing optical spectra from one embodiment of a BiDFA system with the spectra representing a transmitter output, a BiDF input after 40 kilometers (km) transmission, and an amplifier output.

FIG. 3B is a graph showing average bit-error rate (BER) as a function of signal power for a 40 km link of G.652 transmission fiber and a variable optical attenuator (VOA) compared to back-to-back performance for the BiDFA system that was used to obtain the graph of FIG. 3A.

FIG. 3C is a table showing BER for different wavelength channels in the BiDFA system from FIG. 3A.

FIG. 3D is a graph showing BER degradation as a function of optical signal-to-noise ratio (OSNR) for the BiDFA system from FIG. 3A.

FIG. 3E is a graph showing BER for various transmission distances using the BiDFA system from FIG. 3A.

FIG. 4A is a graph showing optical spectra from another embodiment of a BiDFA system in which the signal is pre-amplified with another BiDFA, with the spectra representing a transmitter output, a BiDF input, and an amplifier output.

FIG. 4B is a graph showing BER for various transmission distances using the BiDFA system from FIG. 4A.

FIG. 4C is a table showing BER for different wavelength channels in the BiDFA system from FIG. 4A.

FIG. 5 is a diagram showing one embodiment of a BiDFA system having cascaded amplifying stages.

FIG. 6 is a diagram showing one embodiment of a BiDFA having an additional optical source.

FIG. 7 is a graph showing an improvement in optical loss for the BiDFA of FIG. 6.

### DETAILED DESCRIPTION OF THE EMBODIMENTS

Recently, the total O-band transponder rate was increased to 425 gigabits per second (Gb/s) by using, for example, eight (8) local area network (LAN) wavelength division multiplexed (WDM) channels modulated by approximately 26.6 gigabaud per second (˜26.6 Gbaud/s) four-level pulse amplitude modulated (PAM-4) signals. The use of LAN WDM and complex modulation format reduces both power-per-channel available at the receiver and receiver sensitivity, thereby making optical amplification desired. Although semiconductor optical amplifiers can be used to boost O-band signals, the semiconductor optical amplifiers introduce distortions due to self-gain modulation and cross-gain modulation. Thus, the semiconductor optical amplifiers are not suitable for WDM transmission of complex intensity modulation formats, such as PAM-4.

Praseodymium-doped fiber amplifiers (PrDFA) with a gain bandwidth between approximately 1280 nanometers (˜1280 nm) and ˜1320 nm are used in some O-band applications. However, PrDFA require non-silica host glass, thereby making PrDFA both expensive and complicated.

To address these shortcomings, this disclosure teaches a silica-based bismuth (Bi) doped fiber amplifier (BiDFA) that permits extension of both O-band transmission reach and O-band transmission capacity. The disclosed silica-based BiDFA has a six decibel (6 dB) gain bandwidth of more than ˜60 nm. The center of the gain band is dependent on pump wavelength and can be flexibly centered between ˜1305 nm and ˜1325 nm. The BiDFA uses an optical fiber that is substantially free of erbium (Er) while exhibiting parameters that are comparable to Er-doped fiber amplifier (ErDFA) systems. The disclosed embodiments are capable of extending a 400GBASE-LR-8 transmission distance to beyond approximately forty kilometers (˜40 km) of an optical fiber that complies with the ITU-T G.652 industry standard.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

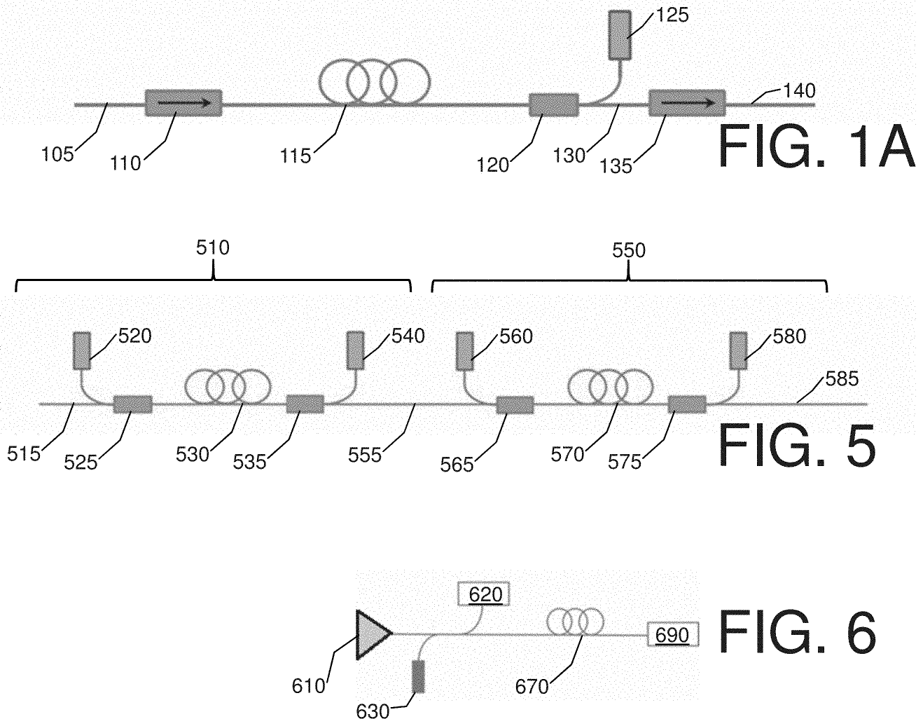

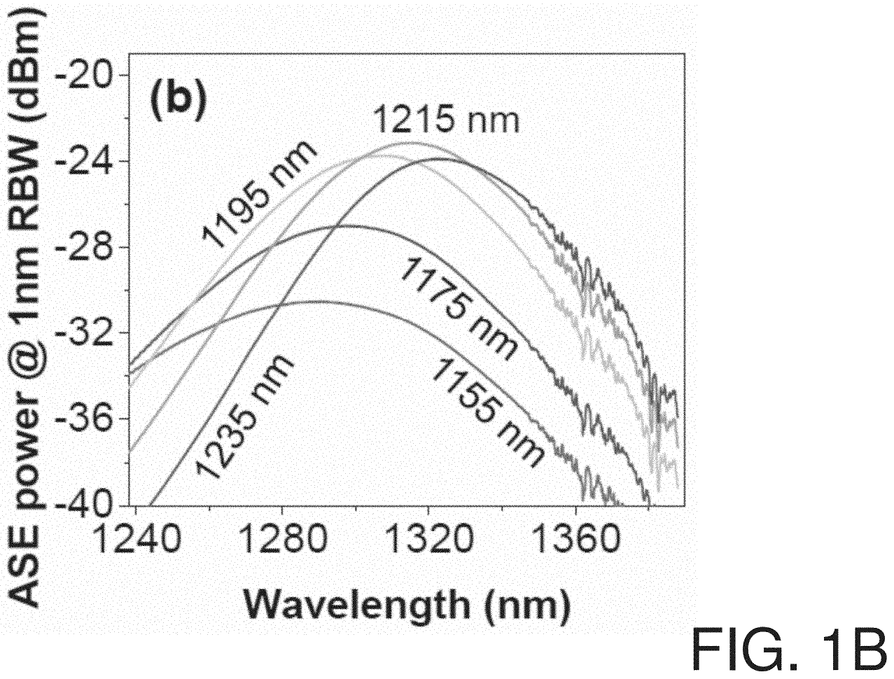

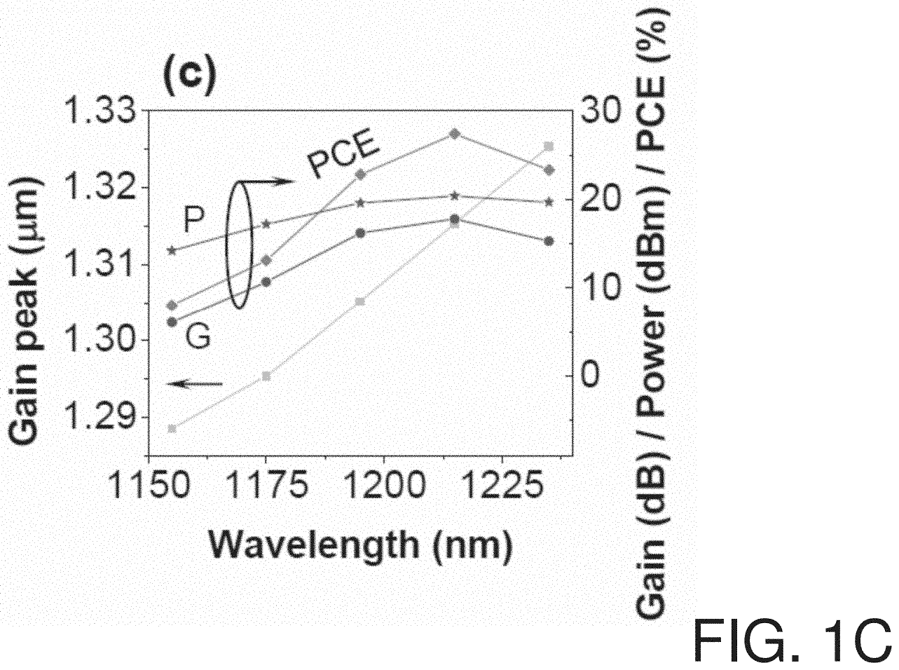

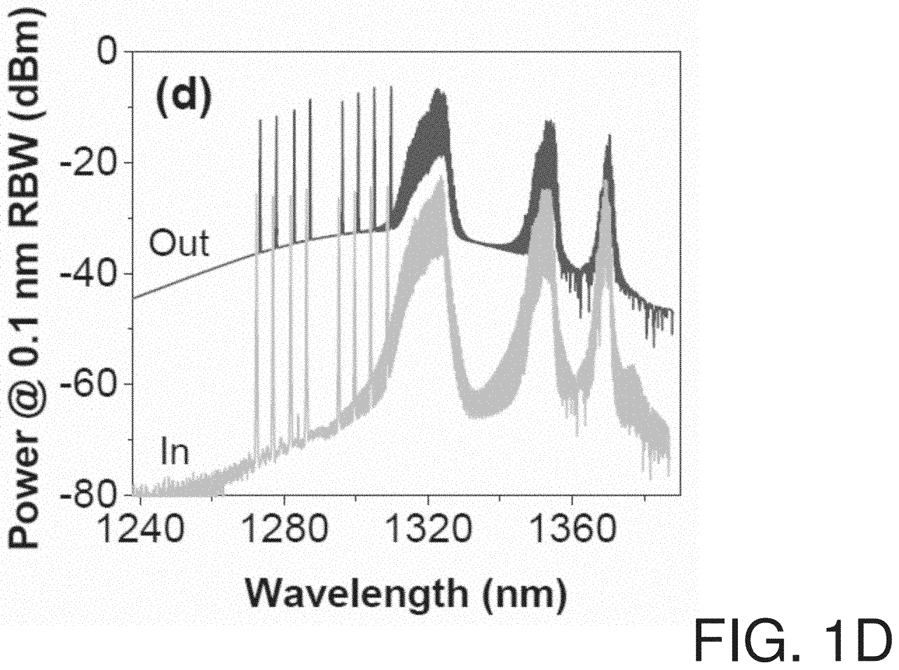

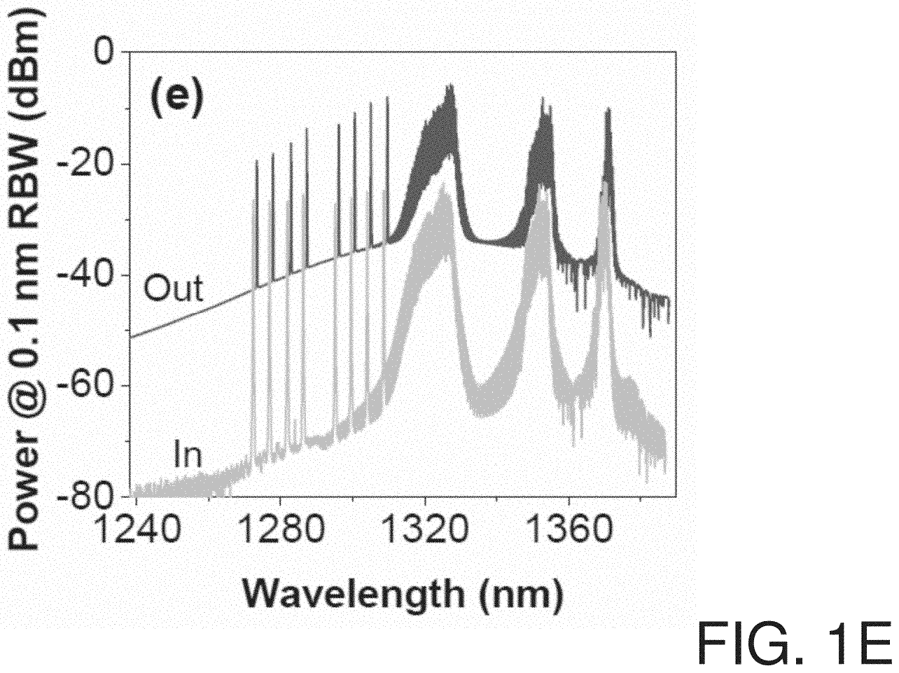

FIG. 1A is a diagram showing one embodiment of a system comprising bismuth (Bi) doped optical fiber (or Bi-doped fiber (BiDF)). Specifically, FIG. 1A shows an optical amplifier system with a signal input 105, a first optical isolator 110 coupled to the signal input 105, and a BiDF 115 optically coupled to the first optical isolator 110. The BiDF 115 is optically coupled to a broadband three decibel (3 dB) coupler 120, which permits introduction of pump light through a counter-pumped optical pump source 125. It should be appreciated that the BiDF 115 can also be pumped using a co-pumping scheme or a combination of co-pumping and counter-pumping schemes. Insofar as co-pumping and counter-pumping schemes are known in the art, further discussion of co-pumping and counter-pumping schemes is omitted herein. An output transmission fiber 130 carries signal from the 3 dB coupler 120 to a second optical isolator 135 and, thereafter, to a signal output 140.

In the embodiment of FIG. 1A, the BiDF 115 comprises a Bi-doped core of phosphosilicate glass having a Bi concentration of less than approximately 0.01 mole percent (<0.01 mol %). As is known in the art, manufacturing processes such as modified chemical vapor deposition (MCVD) or using a glass tube to form a cladding of a preform while the components of the core (e.g., compounds of Silicon (Si), Phosphorous (P), and Bi) are deposited from a gas phase.

Other manufacturing processes, known in the art, can produce the BiDF 115.

When manufactured, the BiDF 115 has a core diameter of approximately seven micrometers (˜7 μm), an index difference of approximately 6e-3 (˜0.006) between the core and the cladding, and a cutoff wavelength of ˜1100 nm. The ˜7 μm core diameter permits good splice-matching with other silica-based optical fibers. Insofar as those having ordinary skill in the art understand MCVD and other BiDF manufacturing processes, further discussion of the optical fiber manufacturing processes is omitted herein.

The system, as shown specifically in FIG. 1A, comprises a BiDF 115 that is approximately eighty meters (˜80 m) in length that is counter-pumped by one or more pump sources 125 with a center wavelength (λ3) that is between ˜1155 nm and ˜1255 nm. Specifically, the embodiment of FIG. 1A uses one (1) pump selecting five (5) different center wavelengths of ˜1155 nm, ˜1175 nm, ˜1195 nm, ˜1215 nm, and ˜1235 nm. Also, for the embodiment of FIG. 1A, the signal input 105 comprises a distributed feedback (DFB) laser operating at ˜1310 nm and fiber gain (G), saturated output power, and power conversion efficiency (PCE), all shown in FIG. 1C, were measured from an eight-channel comb from an output of a 400GBASE-LR8 transceiver with a wavelength range of ˜1272 nm to ˜1310 nm.

The transmission fibers and the BiDF 115 are spliced with standard splicers and automatic splicing programs, which are known to those having skill in the art. While it is shown in FIG. 1A that one (1) of five (5) pump sources 125 may be utilized, additional embodiments may allow for any number of pump sources to be used in any combination. Such embodiments may be used to broaden the gain bandwidth.

FIG. 1B shows amplified spontaneous emissions (ASE) spectra for all five (5) pump wavelengths at approximately 275 milliwatts (˜275 mW) of pump power. As shown in FIG. 1B, there is a ˜0.5 nm shift of ASE intensity peak per ˜1 nm pump. Furthermore, the ASE spectra exhibit a bell-shaped curve with a 3 dB bandwidth of ˜60 nm and a 6 dB bandwidth of ˜85 nm.

At an input power of approximately ˜2 decibel-milliwatts (˜2 dBm), the pump-wavelength (λ3) dependency of G, power, and PCE are shown in FIG. 1C. Specifically, for the embodiment of FIG. 1A, the amplifier system yields G of ˜15 dB to ˜18 dB, power of ˜20 dBm, and a PCE of ˜23% to ˜27% for λ3 of ˜1195 nm to ˜1235 nm. For shorter λ3 (at pump power of ˜400 mW), all parameters decay sharply. It should be appreciated that an input signal range of ˜1272 nm to ˜1380 nm is covered by using an LR-8 transceiver in combination with three (3) Fabry-Perot lasers. Input (approximately ˜6 dBm total signal power) spectra for 400 mW pump power and output spectra at ˜1195 nm and ˜1235 nm are shown in FIG. 1D and FIG. 1E, respectively. The gain peak coincides with the ASE peak wavelength and the 6 dB gain bandwidths are at least ˜80 nm over λ3 range of ˜1195 nm to ˜1235 nm. Based on FIGS. 1B through 1E, the optical amplifier system of FIG. 1A exhibits a gain of at least ˜16 dB for a gain fiber length of ˜80 m. For that same length, the system exhibits a PCE of at least ˜20%, and an output power of at least ˜16 dBm.

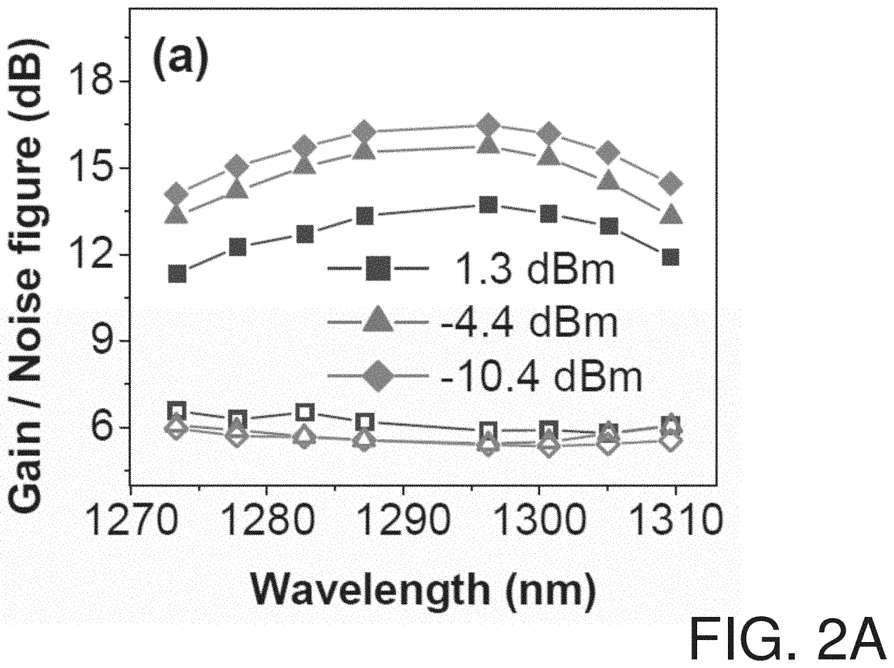

For another embodiment, the second optical isolator 135 is removed (to simplify design and improve performance) and the 3 dB coupler 120 is replaced with a fused fiber wavelength division multiplexer (WDM) transmitting light over a wavelength range covering both the signal and pump (in which induced a loss may be up to ˜4 dB). Gain for short wavelength channels is increased for λ3 of ˜1195 nm. For the WDM embodiment, a graph of G and noise figure (NF) for ˜500 mW pump power is shown in FIG. 2A, while a graph of G and NF at ˜750 mW pump power is shown in FIG. 2B. As shown in FIGS. 2A and 2B, over a wavelength range between ˜1272 nm and ˜1310 nm, the amplifier system has a maximum G of ˜18 dB with a ˜2 dB gain flatness and ˜5 dB typical NF, with ˜5.5 dB being the highest NF at ˜1272 nm.

BiDFA performance is tested with a 400GBASE-LR8 transceiver and a ONT-604 tester. The tester generates 16×26.6 gigabits per second (Gb/s) 2³¹-1 pseudorandom binary sequence (PRBS) on-off keyed (OOK) data lanes at the transmitter side, while detecting individual bit error rates (BER) for each of the 16 receiver-side lanes. The 400GBASE-LR8 transceiver combines the 16 OOK data lanes into 8×26.6 Gbaud/s pulse-amplitude modulated PAM-4 channels and transmits them using a set of eight (8) directly-modulated lasers. At the receiver side, eight (8) WDM channels are demultiplexed (using a filter width that is greater than ˜4 nm), detected, and converted into 16 digital signal lanes. The transceiver signal (at ˜11.7 dBm) is launched into ˜40 km to ˜55 km of optical fiber or a variable optical attenuator (VOA) and amplified by the BiDFA. To control received power, another VOA is placed between the BiDFA and the transmission fiber (compliant with G.652, meaning a transmission center wavelength of ˜1312 nm and a loss of ˜0.33 dB at ˜1310 nm).

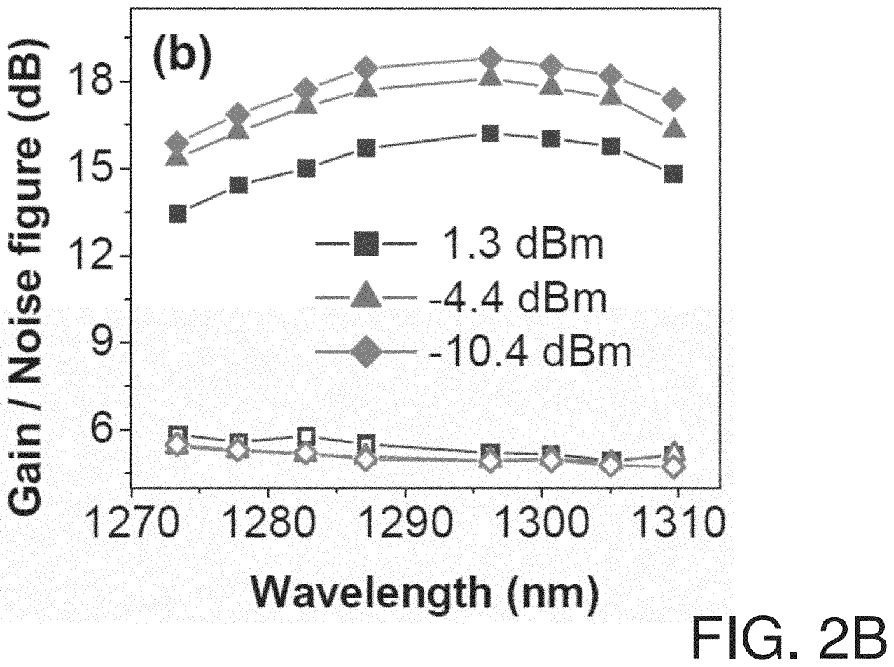

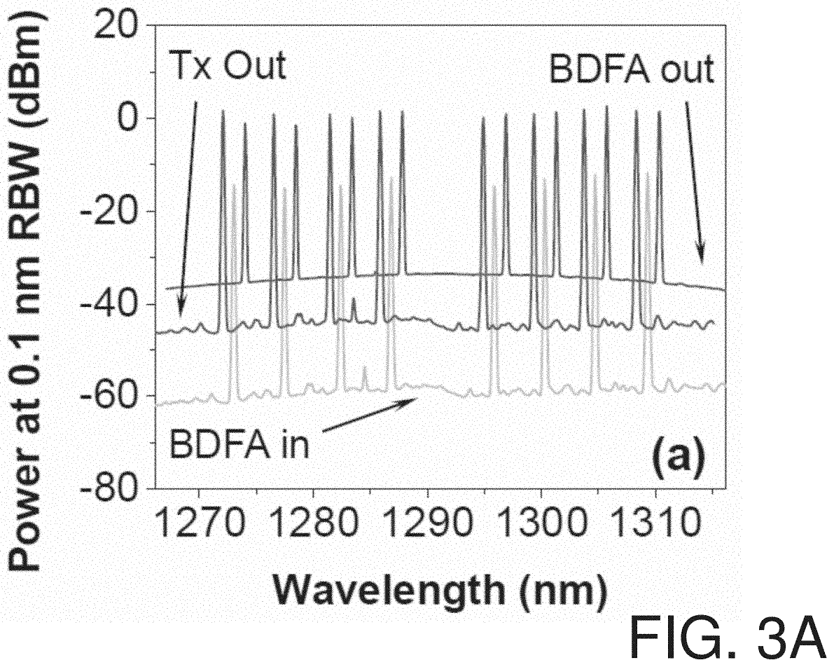

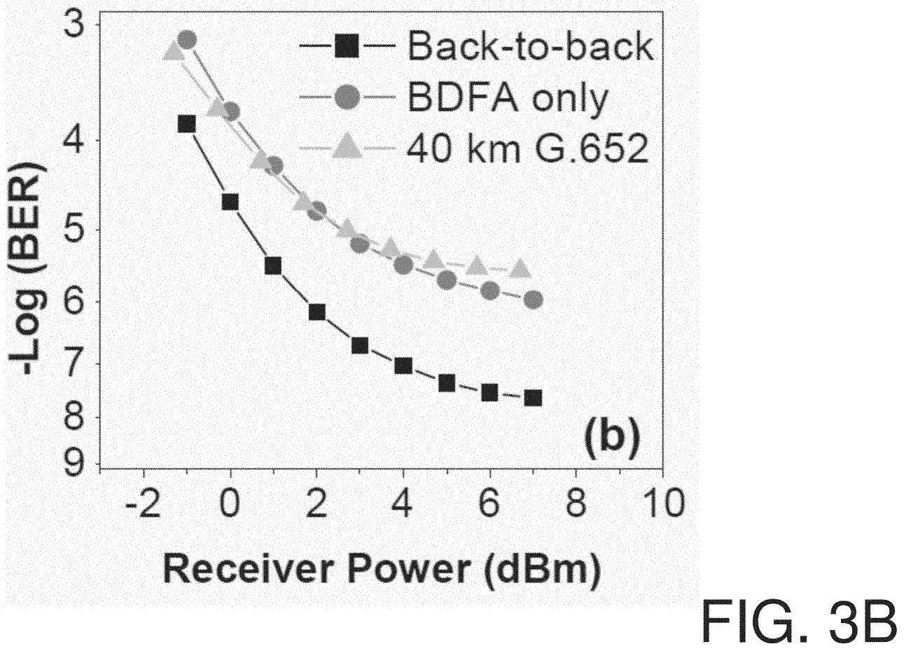

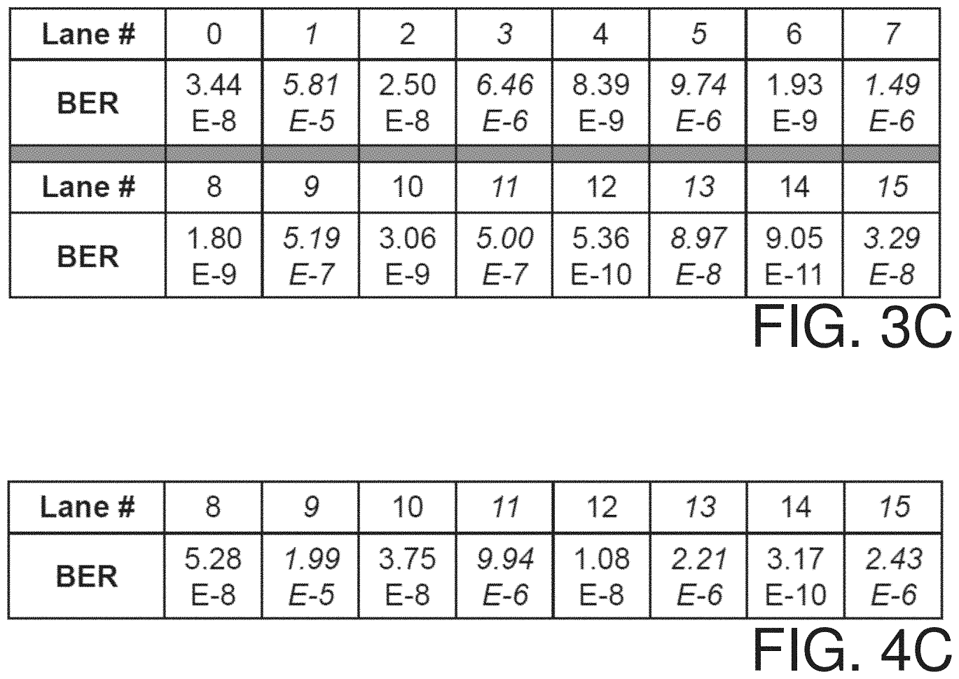

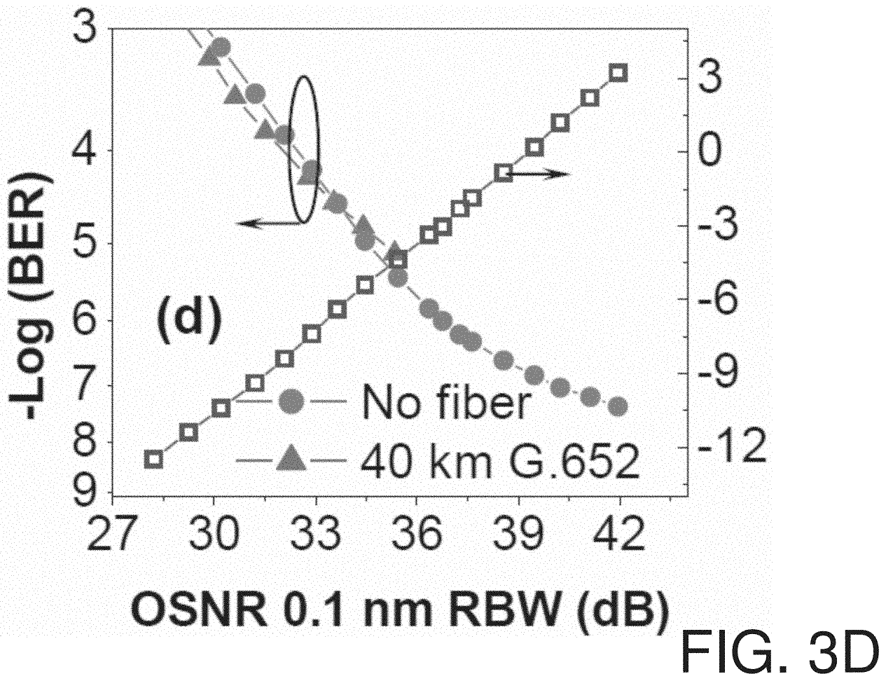

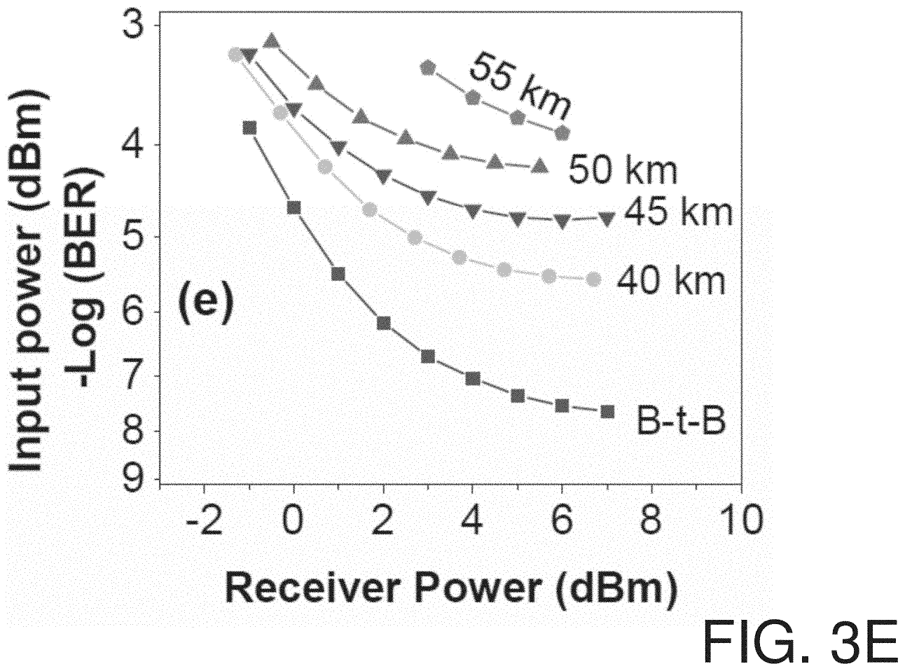

FIG. 3A shows optical spectra after transmission (G.652 fiber and BiDFA). Specifically, FIG. 3A shows a transmitter output, the BiDF input after ˜40 km, and the BiDFA output. In FIG. 3A, a wavelength shift is added to increase visibility. The system exhibits an average fiber loss of ˜14.6 dB (including connectors), while short wavelength channels suffer up to ˜2 dB higher loss compared to long wavelength channels. For practical purposes, the pump power is restricted to ˜500 mW.

With these parameters, average bit-error rate (BER) as a function of signal power for a ˜40 km transmission fiber and 14.6 dB VOA are compared to back-to-back performance in FIG. 3B. Power penalty at 1e-5 BER is less than ˜2 dB for both VOA and transmission fiber, while long-term BER (for greater than ˜8 hours) is 5e-6 for amplified transmission over a distance of ˜40 km.

FIG. 3C is a table showing BER for different wavelength channels in the BiDFA system from FIG. 3A. As shown in FIG. 3C, short wavelength channels have higher BER and the channel BER decreases with wavelength. This wavelength dependency is attributable to higher accumulated dispersion in short wavelength channels (as compared to long wavelength channels), in addition to ˜3 dB lower received power and ˜2 dB lower optical signal-to-noise ratio (OSNR).

Inserting a VOA between the G.652 fiber and the BiDFA, maintaining received power at ˜6 dBm, and maintaining a ˜3 dB difference between the best and worst channels permit investigation of BER degradation from OSNR, which is degraded since amplifier produces ASE noise, and, also, permit an estimate of link loss margin. This is shown in FIG. 3D. For transmitter power of ˜11.7 dBm and a ˜40 km fiber span with ˜14.6 dB loss, a loss of up to ˜1.8 dB can be added before a BER of 1e-5 is reached. As shown in FIG. 3E, it is also possible to measure BER in all lanes for distances of up to ˜55 km. However, with increased distances, the error floor gradually increases to ˜1.3e-4.

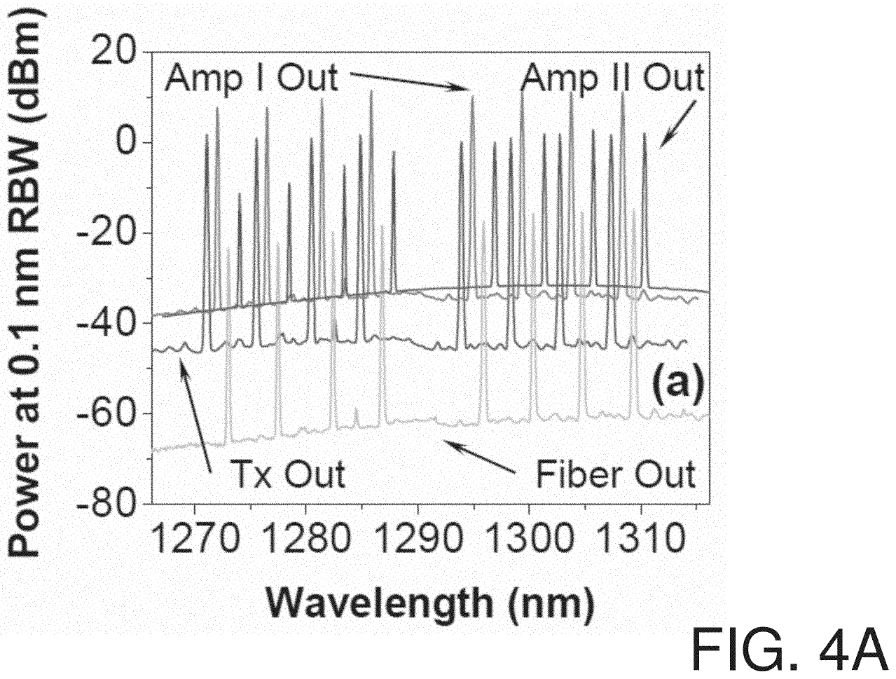

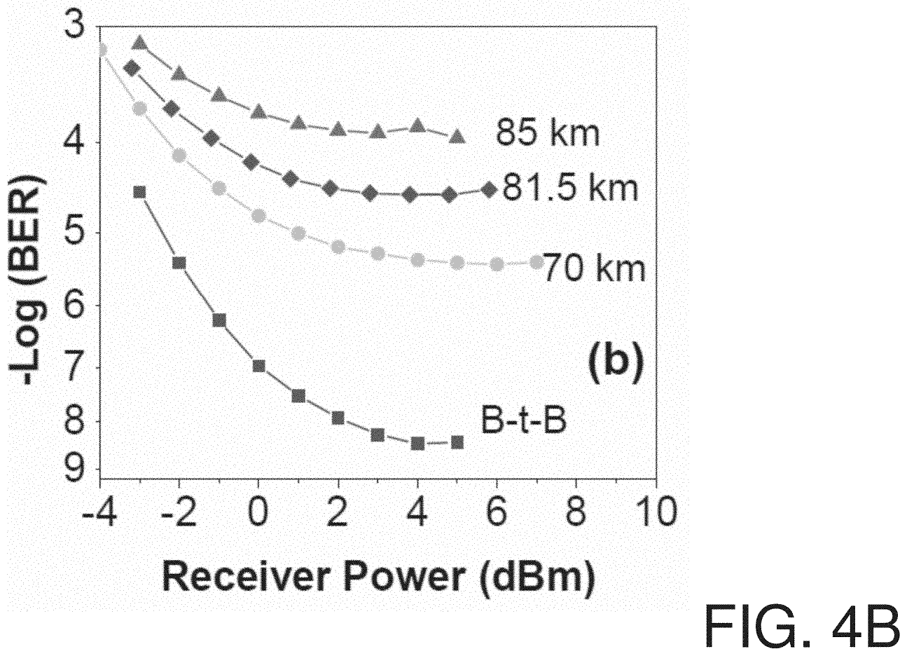

FIG. 4A is a graph showing optical spectra from another embodiment of a BiDFA system in which the signal is pre-amplified with another BiDFA (Amp I) in addition to the receiver post-amplification (Amp II). The displayed spectra represent transmitter output, BiDF input, and BiDFA output. Specifically, the system had a total output power of ˜20.8 dBm (λ3 of ˜1215 nm and pump power of 750 mW). Although channels 1 through 4 continued to transmit, only the BER data from channels 8 through 15 are shown in FIG. 4C. BER for G.652 fibers having transmission lengths of ˜70 km, ˜81.5 km, and ˜85 km are shown in FIG. 4B. As seen in FIGS. 4A, 4B, and 4C, and specifically by the long-term error floor of 3e-5 in the ˜81.5 km transmission length, short wavelength channels limit the transmission distance. Furthermore, for some embodiments, the amplifier system exhibits a bleaching effect wherein the amplifier signal PCE increases with input signal power.

For some embodiments, amplifying stages for the BiDFA can be cascaded. One such embodiment is shown in FIG. 5. Specifically, the embodiment of FIG. 5 comprises a first amplifying stage 510 and a second amplifying stage 550, which are optically coupled together by a connecting fiber 555. It should be appreciated that additional amplifying stages can be cascaded as needed. As shown in FIG. 5, the first stage 510 comprises a signal input 515, a first pump source 520, and a first WDM 525 that combines the signal with the pump in a co-pumping configuration (or scheme). The first stage 510 further comprises a first BiDF 530 that is optically coupled to an output of the first WDM 525. The first stage 510 further comprises a second pump source 540 and a second WDM 535 that optically couples the pump light from the second pump source 540 to the first BiDF 530 in a counter-pumping configuration (or scheme).

The second stage 550 comprises a signal input 515, a third pump source 560, and a third WDM 565 that combines the signal with the pump in a co-pumping configuration (or scheme). The second stage 550 further comprises a second BiDF 570 that is optically coupled to an output of the third WDM 565. The second stage 550 further comprises a fourth pump source 580 and a fourth WDM 575 that optically couples the pump light from the fourth pump source 580 to the second BiDF 570 in a counter-pumping configuration (or scheme). The fourth WDM 575 is optically coupled to a signal output 585.

It should also be appreciated that for some embodiments the bleaching for the first amplifying stage 510 is different from the bleaching for the second amplifying stage 550, while for other embodiments the bleaching for the two stages 510, 550 are the same. The difference in bleaching is accomplished by, for example, changing the Bi concentrations in the gain fiber. Consequently, certain parameters of the overall cascaded system (e.g., overall system gain, output power, etc.) are improved by improving certain parameters (e.g., gain, bleaching level, etc.) at each amplifying stage 510, 550. Furthermore, it should be appreciated that some of the pumps are redundant and, thus, can be omitted (e.g., a co-pumping-only scheme can be used, a counter-pumping-only scheme can be used, or a combination of both co-pumping and counter-pumping schemes (as shown in FIG. 5) can be used, etc.). Also, each additional stage is configurable with one or more different types of gain fibers (e.g., Bi-doped, Er-doped, etc.). Moreover, each pump is configurable to a single pump wavelength or multiple pump wavelengths, as needed. Additionally, each pump source can operate at either the same wavelength as other pump sources or at different wavelengths from other pump sources.

Turning now to FIG. 6, yet another embodiment of a BiDFA system is shown. Specifically, the embodiment of FIG. 6 shows a BiDFA system comprising a signal source 610 operating at a center wavelength of λS, a pump source 620, and a light source 630 operating at a center wavelength of λA. The pump source 620 can be a single-pump-wavelength source with a center wavelength of λ3 or an aggregate of more than one pump sources. In the alternative, an additional pump source having a center wavelength of λ4 can be added to the configuration of FIG. 6.

For some embodiments, multiple pump wavelengths can be multiplexed together to exhibit many different center wavelengths (λ3), each corresponding to its respective pump source. In some embodiments, λ3 (or λ4, depending on the configuration) is between ˜1155 nm and ˜1255 nm. Specifically, for some embodiments, λ3 (or λ4, depending on the configuration) includes wavelengths of ˜1155 nm, ˜1175 nm, ˜1195 nm, ˜1215 nm, and ˜1235 nm. For multiple pump sources, a VOA balances the output power of λ3 (or λ4).

The signal source 610, pump source 620, and the light source 630 are optically coupled to a BiDF 670. The BiDF 670 has a gain band and an auxiliary band. The gain band has a center wavelength of λ1. For some embodiments, λ1 is between ˜1305 nm and ˜1325 nm. The auxiliary band has a center wavelength of λ2 and a light source in the auxiliary band has a wavelength λA. For some embodiments, λA is ˜1405 nm. The gain band has a 6 dB gain bandwidth that is at least ˜60 nm. For some embodiments, the 6 dB gain bandwidth and the center wavelength λ1 is λ3-dependent. Preferably, the BiDF 670 is substantially free of Er. The system of FIG. 6 further comprises an optional optical signal analyzer (OSA) 690 or other signal output. According to some embodiments, λA may be within a range of ˜1360 nm to ˜1500 nm (λ2b), or alternatively, a range of ˜1240 nm to ˜1280 nm (λ2a).

The additional light source 630 improves amplifier efficiency by decreasing signal loss at λS (or increasing the signal gain at λS). Specifically, Bi is known to have an excitation and emission band in the ˜1200 nm range (λ2a), ˜1300 nm range (o-band) and the ˜1400 nm range (λ2b). By adding optical power at λ2 above the certain power level, signal excitation may be increased due to reduction in bleaching. Thus, exciting λA (in either λ2a or λ2b) results in an increased signal gain in the gain band (e.g., ˜1260 nm to ˜1360 nm) by somewhere between ˜6 dB and ˜10 dB. This is because gain and efficiency are sensitive to competition between a ground state ion population and an excited state ion population. In particular, higher inversion levels are necessary for higher gains. However, at low input signal power (e.g., less than approximately −10 dBm), emission at out-of-band wavelengths (e.g., λA of ˜1200 nm in range λ2a or λA of ˜1400 nm in range λ2b) can divert power and reduce inversion levels. This diversion effect can be compensated to some degree by introducing out-of-band light at λ2. Relative locations of λS, λ2a, λ2b and λ3 are summarized as follows: λS is located within O-band (at ˜1260 nm to ˜1360 nm); λ3 is located below ˜1240 nm (typically within ˜1195 nm to ˜1240 nm); λ2a is located below the O-band; and λ2b is located above the O-band.

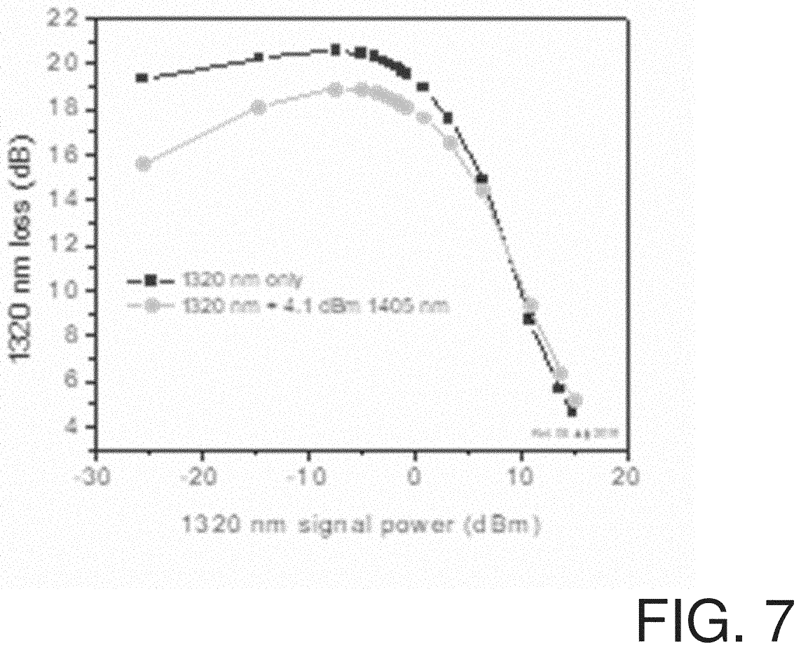

By way of example, for λA of ˜1405 nm and λS of ˜1320 nm, if a lower power level (e.g., ˜4 dBm) λA signal is introduced to a small λS signal (e.g., approximately ˜10 dBm) in the presence of a larger pump signal (e.g., larger than ˜20 dBm) at λ3, then an excitation at λA increases amplification efficiency at therefore gain of ˜6 dB to ˜10 dB at λ1. An example of this is shown in FIG. 7. In particular, FIG. 7 is a graph comparing λ1 signal loss in a ˜100 m BiDF. Specifically, signal loss is compared with and without the light source 630. As shown in FIG. 7, adding ˜4.1 dBm at λA of ˜1405 nm reduces attenuation (loss) in the BiDF 670 from ˜19 dB/100 m to ˜15.3 dB/100 m, which is ˜3.7 dB reduction in signal loss, which in turn translates to an increase in small-signal gain by ˜6 dB to ˜10 dB if extended to two polarizations. Thus, for communications in which the data carrying signal in the O-band is in the range of approximately ˜30 dBm to approximately +3 dBm, the addition of an additional light source 630 in a neighboring excitation band (λ2) increases amplifier efficiency. It is noted that light source 630 may be either a laser or broadband source.

Another approach to improving amplifier efficiency, especially for small signals (e.g., less than ˜10 dBm), is to modify waveguide properties of the core of the BiDF. As noted above, inversion is dependent to some degree on competition between the excited state and the ground state. Thus, one approach to increasing inversion levels is to increase the intensity of the pump light (λ3).

The intensity of the pump light (at λ3) can be increased by reducing the mode-field area (MFA) of the waveguide. The MFA of the waveguide can be reduced by increasing core index (e.g., by increasing the concentration of non-gain-producing co-dopants in the core) and reducing core diameter. Preferably, the non-gain-producing co-dopants, such as Lanthanum (La) or Lutetium (Lu), do not alter the gain properties of Bi from the desired P-doped silica glass. Alternatively, the MFA of the waveguide can be reduced by decreasing the cladding index, which can be done with Fluorine (F) doping. Regardless of the process by which MFA is reduced, a reduction in the MFA for BiDF produces a corresponding improvement in BiDFA efficiency. It should also be noted that a P—Bi—SiO₂ core produces a desirable gain at ˜1300 nm, but Germanium (Ge) or Aluminum (Al) co-dopants (e.g., in a Ge—Bi—SiO₂ core or an Al—Bi—SiO₂ core) do not produce comparably-desirable gains.

Although exemplary embodiments have been shown and described, it will be clear to those of ordinary skill in the art that a number of changes, modifications, or alterations to the disclosure as described may be made. For example, while most values are provided as approximate values (using “˜”), these approximate values also include the precise numerical value and, thus, the approximation reflects a margin of error to the nearest significant figure. All such changes, modifications, and alterations should therefore be seen as within the scope of the disclosure.

What is claimed is:

1. An optical amplifier system comprising:
(a) a system operating wavelength that is between approximately 1260 nanometers (˜1260 nm) and ˜1360 nm;
(b) a system gain of at least approximately three decibels (˜3 dB);
(c) a system power conversion efficiency (PCE) of at least approximately five percent (˜5%);
(d) a system noise figure of ˜5.5 dB;
(e) a system output power of at least approximately one decibel-milliwatts (˜1 dBm);
(f) a pump source for providing pump light at a pump wavelength (λ3) of between ˜1155 nm and ˜1255 nm;
(g) a Bismuth (Bi) doped optical fiber optically coupled to the pump source, the Bi-doped optical fiber for amplifying an optical signal, the Bi-doped optical fiber comprising:
(g1) a gain band comprising:
(g1A) a first center wavelength (λ1) between approximately ˜1305 nm and ˜1325 nm, λ1 being a function of λ3; and
(g1B) a first six decibel (6 dB) gain bandwidth that is greater than ˜40 nm; and
(g2) an auxiliary band comprising a second center wavelength (λ2), λ2 being either between λ1 and λ3 or above λ1;
(h) a signal source optically coupled to the Bi-doped optical fiber, the signal source for providing the optical signal within the gain band to the Bi-doped optical fiber; and
(i) a light source optically coupled to the Bi-doped optical fiber, the light source for introducing light at λ2 to the Bi-doped optical fiber.

2. A system comprising:
a Bismuth (Bi) doped optical fiber comprising:
a gain band comprising:
a first center wavelength (λ1); and
a first six decibel (6 dB) gain bandwidth; and
an auxiliary band comprising a second center wavelength (λ2);
a signal source optically coupled to the Bi-doped optical fiber, the signal source for providing an optical signal within the gain band to the Bi-doped optical fiber;
a light source optically coupled to the Bi-doped optical fiber, the light source for introducing light at λ2 to the Bi-doped optical fiber; and
a pump source optically coupled to the Bi-doped optical fiber, the pump source for providing pump light at a pump wavelength (λ3) to the Bi-doped optical fiber.

3. The system of claim 2, wherein the Bi-doped optical fiber is substantially free of Erbium (Er).

4. The system of claim 2, wherein λ3<λ2 and λ2 λ1.

5. The system of claim 2, wherein λ1 is between approximately 1305 nanometers (˜1305 nm) and ˜1325 nm.

6. The system of claim 2, wherein the gain band has a first six decibel (6 dB) gain bandwidth of approximately sixty nanometers (˜60 nm).

7. The system of claim 2, wherein the gain band has a first six decibel (6 dB) gain bandwidth that is greater than approximately sixty nanometers (˜60 nm).

8. The system of claim 7, wherein λ1 is dependent on λ3.

9. The system of claim 2, wherein λ2 is selected from the group consisting of:
a wavelength between λ1 and λ3;
a wavelength above λ1; and
approximately 1405 nanometers (˜1405 nm).

10. The system of claim 2, wherein the pump source further provides pump light at an additional wavelength (λ4).

11. The system of claim 10, wherein λ4 is one selected from the group consisting of:
˜1155 nm;
˜1175 nm;
˜1195 nm;
˜1215 nm; and
˜1235 nm.

12. The system of claim 10, wherein λ4<λ3.

13. The system of claim 2, wherein the pump source provides pump light using a co-pumping configuration.

14. The system of claim 2, wherein the pump source provides pump light using a counter-pumping configuration.

15. The system of claim 2, wherein the operating wavelength of the system is between approximately 1260 nanometers (˜1260 nm) and ˜1360 nm.

16. The system of claim 15, wherein the operating wavelength of the system is between ˜1272 nm and ˜1310 nm.

17. The system of claim 2, wherein the system has a gain of at least approximately sixteen decibels (˜16 dB) over a distance of approximately 100 meters (˜100 m).

18. The system of claim 2, wherein the system has a power conversion efficiency (PCE) of at least approximately twenty percent (˜20%) over a distance of approximately 100 meters (˜100 m).

19. The system of claim 2, wherein the system has a noise figure of approximately 5.5 decibels (˜5.5 dB).

20. The system of claim 2, wherein the system has an output power of at least approximately sixteen decibel-milliwatts (˜16 dBm) over a distance of approximately 100 meters (˜100 m).
